(19) United States
(12) Patent Application Publication
(10) Pub. No.: US 2026/0362522 A1
(43) Pub. Date: Nov. 12, 2026

(54) APPARATUS AND METHOD FOR SUPPORTING EXTENDED REALITY AND MEDIA TRAFFIC IN A WIRELESS COMMUNICATION NETWORK

(71) Applicant: Lenovo (Singapore) Pte. Ltd., Singapore (SG)

(72) Inventors: Apostolis SALKINTZIS, Athens (GR); Dimitrios KARAMPATSIS, Ruislip (GB)

(21) Appl. No.: 19/139,181

(22) PCT Filed: Feb. 7, 2023
(86) PCT No.: PCT/EP2023/052932

§ 371 Date: Jun. 13, 2025

(30) Foreign Application Priority Data
Dec. 16, 2022 (GR) 20220101046

(51) Int. Cl. H04W 76/15; H04W 48/18; H04W 60/04; H04W 80/06

(52) U.S. Cl. CPC H04W 76/15; H04W 48/18; H04W 60/04; H04W 80/06

(57) ABSTRACT

There is provided a network node in a wireless communication network, comprising a processor; and a memory coupled with the processor. The processor configured to cause the network node to receive a data stream from a data network external to the wireless communication network, for transmission via a multiaccess data connection to a first network node of the wireless communication network, wherein the multiaccess data connection comprises a plurality of access networks; determine the data stream comprises at least a first packet data unit ‘PDU’ set, wherein each PDU set comprises one or more PDUs; determine steering information associated with the data stream; select, for each PDU set, an access network from the plurality of access networks, based on the steering information; and transmit to the first network node, each PDU set, using PDU set scheduling, wherein the PDU set scheduling comprises transmitting all PDUs of a respective PDU set using the respective selected access network for that PDU set.

### FIELD

The subject matter disclosed herein relates generally to the field of implementing enhancements for supporting extended reality and media traffic in a wireless communication network. This document defines a network node and a method in a network node, in a wireless communication network.

### Introduction

The Access Traffic Steering, Switching, Splitting (ATSSS) feature specified in 3^{rd} Generation Partnership Project (3GPP) specifications enables the data traffic between a user equipment (UE) and a user plane function (UPF) to be exchanged over multiple access networks, typically, over one 3GPP access network (e.g. a next generation radio access network (NG-RAN)) and one non-3GPP access network (e.g. a wireless local area network (WLAN)). The data traffic is distributed across the 3GPP and non-3GPP access networks based on steering policies (aka ATSSS policies) provided by the 3GPP network.

For example, a steering policy may indicate that data traffic of an application should be equally distributed (50%-50%) across the two access networks, in both the uplink and downlink directions, or that the data traffic arriving from a remote host should be sent to a UE over non-3GPP access only, while it should switch over to 3GPP access when the non-3GPP access is unavailable. The first of these steering policies applies a so-called ‘Load-Balancing’ steering mode, where the traffic is split over both accesses using certain split percentages, while the second of these policies applies a so-called ‘Active-Standby’ steering mode, where the traffic is sent on the active access (non-3GPP) only when available and switches over to the standby access (3GPP) when the active access becomes available.

The ATSSS feature is meant to be applied to any type of traffic, including video traffic, voice traffic, messaging, web browsing, etc.

### SUMMARY

3GPP has recently specified a new traffic type, called extended Reality and Media (XRM) traffic, which features some properties that make it unapplicable to ATSSS. In other words, the ATSSS feature cannot be used to distribute the XRM traffic across 3GPP and non-3GPP accesses.

XRM video traffic is organized into Packet Data Unit (PDU) sets, i.e., groups of PDUs, which feature similar properties, such as, they carry information from the same video frame.

When XRM traffic enters a 3GPP network at a UPF, the PDU sets should be identified and all PDUs belonging to the same PDU set should be forwarded to a UE via the same access network and using specific Quality of Service (QoS) parameters, called “PDU Set QoS parameters”. For example, each PDU set should be forwarded from a UPF to a UE with a delay not exceeding a defined delay bound (aka PDU Set Delay Budget). Also, each PDU set may be assigned an importance value (e.g., high, medium, low) and each PDU in a PDU set should be handled based on the importance of its PDU set.

Based on the above, if the UPF applies the existing XRM-unaware ATSSS procedures to distribute the traffic of an XRM stream (e.g., of an XRM video traffic stream) across multiple accesses, then the PDUs belonging to the same PDU set may be sent across different accesses. If some PDUs of a PDU set are sent via 3GPP access (gNB) and some other PDUs of the same PDU set are sent via non-3GPP access (a trusted non-3GPP gateway function (TNGF)/or a non-3GPP interworking function(N3IWF)), then: the access network does not receive all PDUs of the PDU set and cannot identify the start and the end of a PDU set; the QoS requirements of the PDU set cannot be fulfilled, e.g., it is not feasible to ensure that the PDU Set Delay Budget will be met; and optimization procedures cannot be applied, e.g., the PDUs of the same low-importance PDU set cannot be discarded if the PDU set Delay Budget cannot be met.

As a consequence, when the XRM traffic is subject to XRM-unaware ATSSS procedures, the 3GPP network is not able to transfer the XRM traffic between the UE and UPF with the necessary optimizations that were defined in 3GPP Release-18.

To address this issue, the ATSSS procedures should be enhanced and special ATSSS behaviour for XRM traffic should be defined.

Disclosed herein are procedures for supporting extended reality and media traffic in a wireless communication network. Said procedures may be implemented by a network node and a method in a network node, in a wireless communication network.

There is provided a network node in a wireless communication network, comprising: a processor; and a memory coupled with the processor, the processor configured to cause the network node to: receive a data stream from a data network external to the wireless communication network, for transmission via a multiaccess data connection to a first network node of the wireless communication network, wherein the multiaccess data connection comprises a plurality of access networks; determine the data stream comprises at least a first packet data unit ‘PDU’ set, wherein each PDU set comprises one or more PDUs; determine steering information associated with the data stream; select, for each PDU set, an access network from the plurality of access networks, based on the steering information; and transmit to the first network node, each PDU set, using PDU set scheduling, wherein the PDU set scheduling comprises transmitting all PDUs of a respective PDU set using the respective selected access network for that PDU set.

There is further provided a method in a wireless communication network, comprising: receiving a data stream from a data network external to the wireless communication network, for transmission via a multiaccess data connection to a first network node of the wireless communication network, wherein the multiaccess data connection comprises a plurality of access networks; determining the data stream comprises at least a first packet data unit ‘PDU’ set, wherein each PDU set comprises one or more PDUs; determining steering information associated with the data stream; selecting, for each PDU set, an access network from the plurality of access networks, based on the steering information; and transmitting to the first network node, each PDU set using PDU set scheduling, wherein the PDU set scheduling comprises transmitting all PDUs of a respective PDU set using the respective selected access network for that PDU set.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for supporting extended reality and media traffic in a wireless communication network will now be described, by way of example only, with reference to the accompanying drawings, in which:

FIG. 1 illustrates an embodiment of a wireless communication network for supporting XRM traffic in a wireless communication network;

FIG. 2 illustrates an embodiment of a UE apparatus;

FIG. 3 illustrates an embodiment of a network node;

FIG. 4 illustrates an example of a remote host generating an XRM video traffic stream that should be terminated at a UE;

FIG. 5 illustrates an example of current ATSSS procedures being applied between an ATSSS-capable UE and a UPF in a 5G Core (5GC) network;

FIG. 6 illustrates an embodiment of a system supporting XRM traffic in a wireless communication network;

FIG. 7 illustrates an embodiment of a method for wireless communication in a wireless communication network;

FIG. 8 illustrates an embodiment of UE requested multiaccess (MA) PDU session establishment supporting XRM traffic in a wireless communication network; and

FIG. 9 illustrates an alternative embodiment of a method for wireless communication in a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of”′ includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

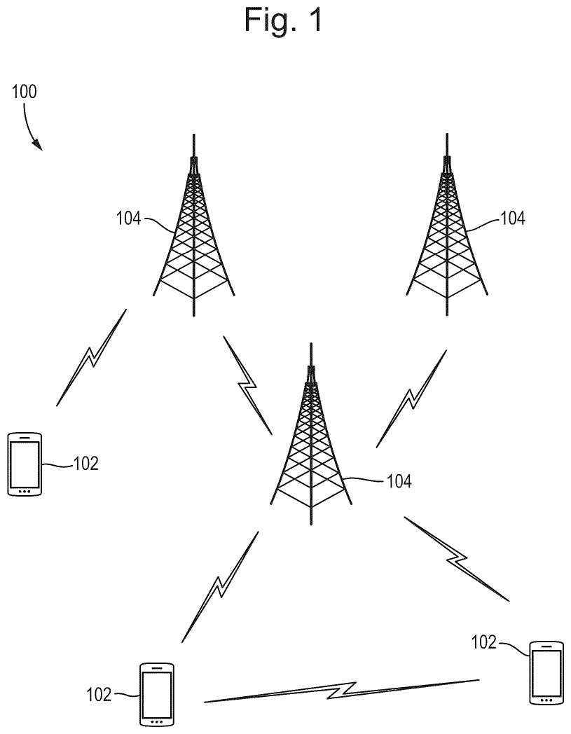

FIG. 1 depicts an embodiment of a wireless communication system 100 for supporting XRM traffic in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WIMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

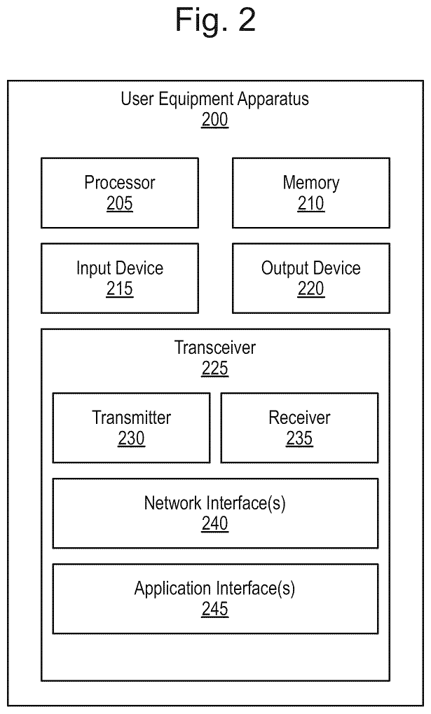

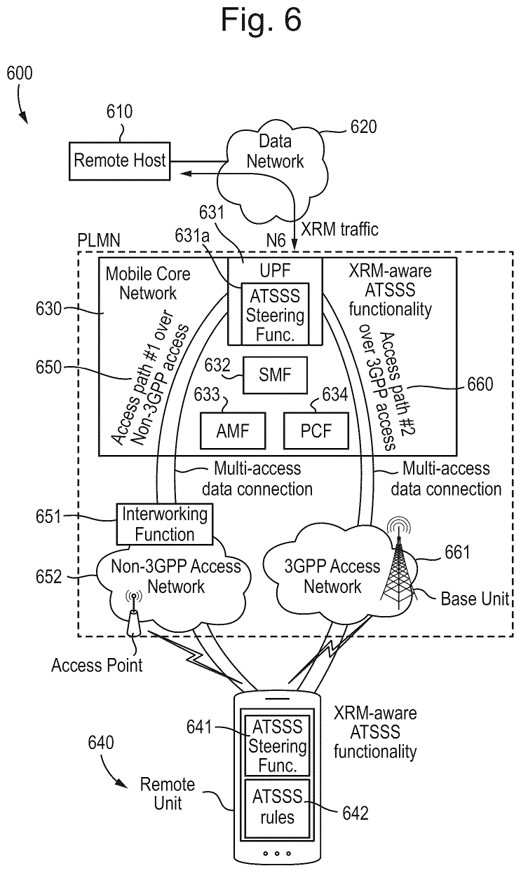

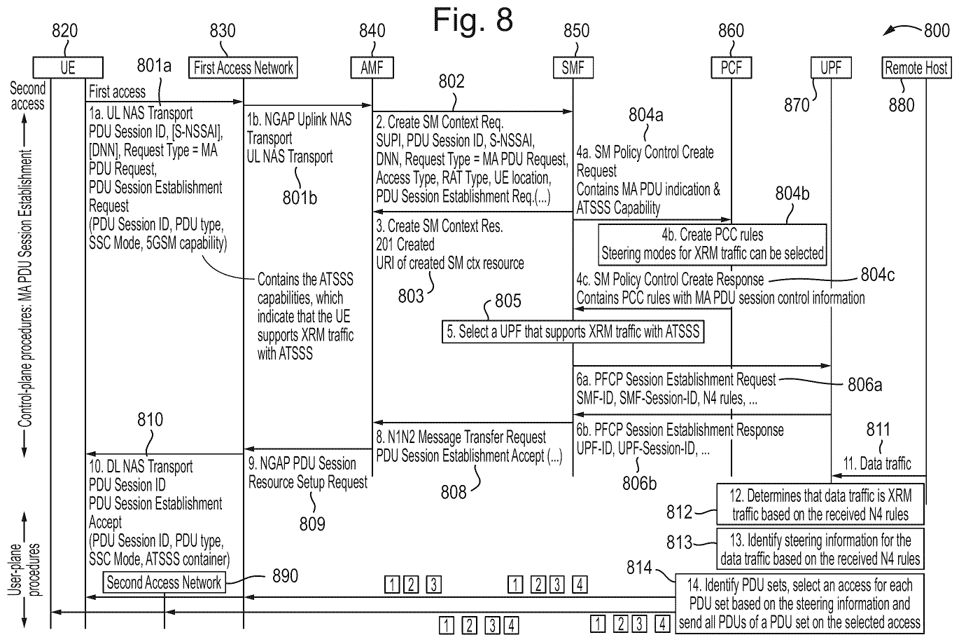

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a UE 102 of FIG. 1, a UE 640 of FIG. 6, or a UE 820 of FIG. 8. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller.

The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display.

The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

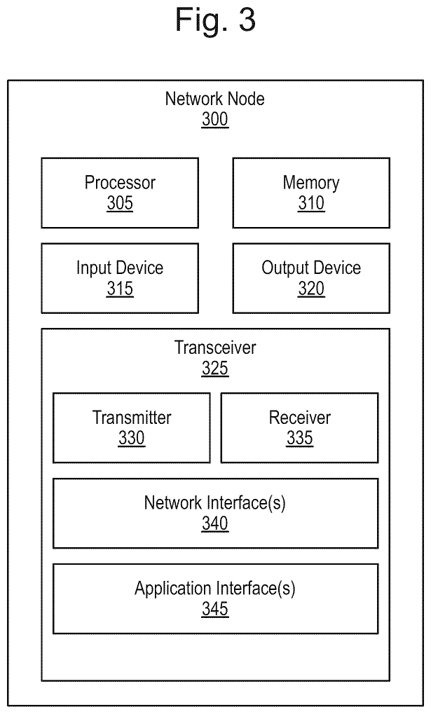

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a UPF 631 of FIG. 6, or a UPF 870 of FIG. 8, for instance. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

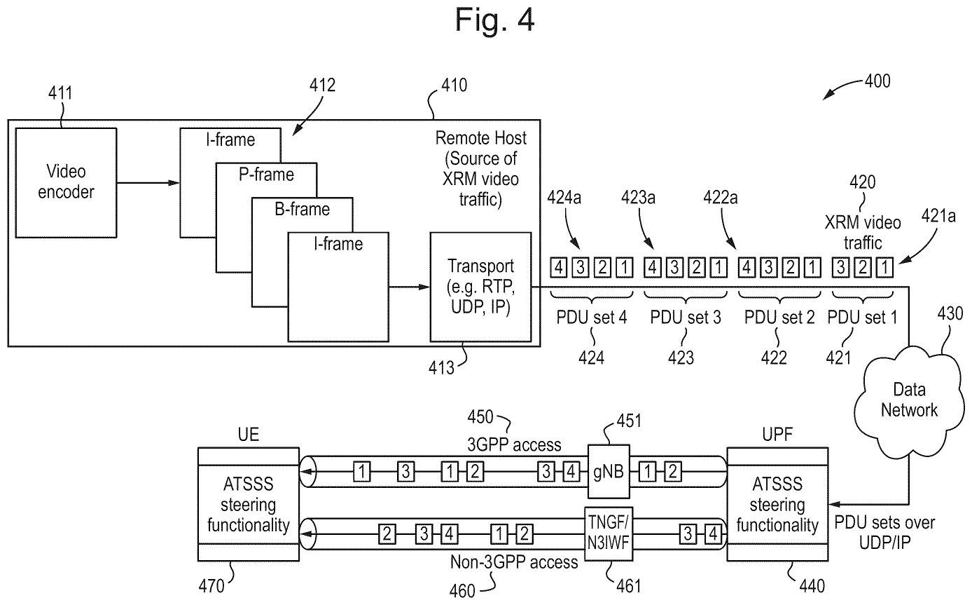

FIG. 4 illustrates an example 400 of a remote host generating an XRM video traffic stream that should be terminated at a UE. The figure shows a remote host 410 (source of XRM video traffic) as comprising a video encoder 411 outputting a plurality of video frames 412 (I-frames, P-frames, B-frames, for instance) which are provided for transport 413 (e.g. RTP, UDP, IP).

An XRM video traffic stream 420 is output from the remote host 410. The XRM video traffic stream 420 comprises a first PDU set 421, a second PDU set 422, a third PDU set 423 and a fourth PDU set 424. Each of the PDU sets 421-424 comprise a individual PDUs 421a, 422a, 423a, 424a, respectively. For instance, the first PDU set 421 comprises three PDUs 421a, the second PDU set 422 comprises four PDUs 422a, the third PDU set 423 comprises four PDUs 423a, and the fourth PDU set 424 comprises four PDUs 424a.

The XRM video traffic stream 420 is provided to a data network 430, which routes the PDU sets 421-424 to a UPF 440.

The UPF 440 has ATSSS steering functionality and is shown having a 3GPP access 450 and a non-3GPP access 460 to a UE 470, the UE 470 also having ATSSS steering functionality. The 3GPP access 450 is shown using a gNB 451. The non-3GPP access is shown using a TNGF/N3IWF 461. The PDUs 421a-424a of the PDU sets 421-424 have been split across the 3GPP access 450 and the non-3GPP access 460 in their provision to the UE 470.

More specifically, the Remote Host 410 generates the XRM video traffic stream 420 that should be terminated to a UE 470. The XRM video traffic 420 is organized into PDU sets 421-424, i.e., groups of Packet Data Units (PDUs) 421a-424a, which feature similar properties, such as, they carry information from the same video frame. When the XRM traffic 420 enters the 3GPP network at a UPF 440, the PDU sets 421-424 should be identified and all PDUs 421a-424a belonging to the same PDU set 421-424 should be forwarded to UE 470 via the same access network (450 or 460) and using specific QoS parameters, called “PDU Set QoS parameters”. For example, each PDU set 421-424 should be forwarded from UPF 440 to UE 470 with a delay not exceeding a defined delay bound (aka PDU Set Delay Budget). Also, each PDU set 421-424 may be assigned an importance value (e.g., high, medium, low) and each PDU 421a-424a in a respective PDU set 421-424 should be handled based on the importance of its PDU set 421-424.

It is clear from the example 400 of FIG. 4 that the UPF 440 applying the existing XRM-unaware ATSSS procedures to distribute the traffic of the XRM stream 420 (e.g., of an XRM video traffic stream) across multiple accesses 450 and 460, results in the PDUs 421a-424a belonging to the same PDU set 421-424 may be sent across different accesses. If some PDUs 421a-424a of a PDU set 421-424 are sent via 3GPP access 450 (gNB 451) and some other PDUs 421a-424a of the same PDU set 421-424 are sent via non-3GPP access 460 (TNGF/N3IWF 461), then the aforementioned problems arise wherein the access network 450 or 460 does not receive all PDUs 421a-424a of the PDU set 421-424 and cannot identify the start and the end of a PDU set 421-424; the QoS requirements of a PDU set 421-424 cannot be fulfilled, e.g., it is not feasible to ensure that the PDU Set Delay Budget will be met; and optimization procedures cannot be applied, e.g., the PDUs 421a-424a of the same low-importance PDU set 421-424 cannot be discarded if the PDU set Delay Budget cannot be met.

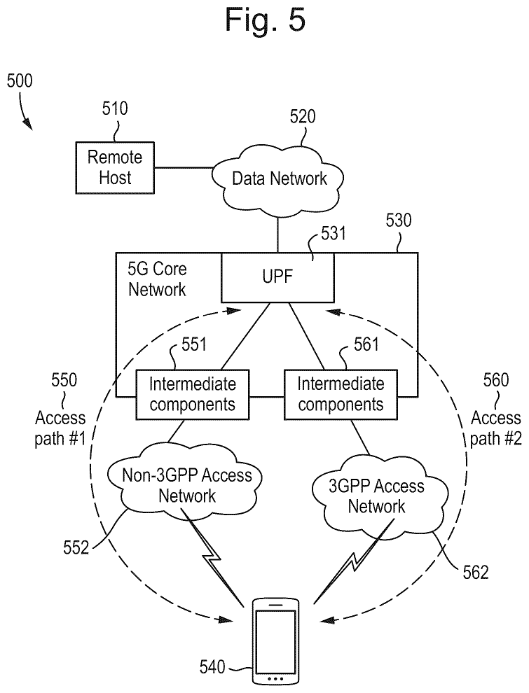

FIG. 5 illustrates an example 500 of current ATSSS procedures being applied between an ATSSS-capable UE and a UPF in a 5G Core (5GC) network. The figure shows a remote host 510, a data network 520, a 5GC network 530 comprising a UPF 531, and a UE 540. A first access path 550 between UPF 531 and UE 540 is illustrated as being via intermediate components 551 and a non-3GPP access network 552. The intermediate components 551 may comprise a TNGF, a N3IWF, or other transport elements, such as IP routers, switches, etc. A second access path 560 between UPF 531 and UE 540 is illustrated as being via intermediate components 561 and 3GPP access network 562. The intermediate components 561 may comprise transport elements, such as IP routers, switches, etc. The first access path 550 and the second access path 560 comprise the access paths of a multiaccess data connection (aka PDU session) between the UPF 531 and UE 540.

More specifically, the figure shows Access Traffic Steering, Switching and Splitting (ATSSS) applied between an ATSSS-capable UE 540 and a UPF 531 in a 5GC network 530. The UE 540 communicates with the Remote Host 510 via the UPF 531 and the traffic between the UE 540 and the Remote Host 510 can be distributed over a first access path 550 using a non-3GPP access network 552 (e.g., WLAN) and over a second access path 560 using a 3GPP access network 562 (e.g., NG-RAN). This traffic can be sent over both access paths 550 and 560 simultaneously or, can be sent on the “best” access only, e.g., on the access characterized by the smallest latency, or the smallest Round-Trip Time (RTT). In the uplink (UL) direction, the UE 540 decides how to distribute the traffic across the two accesses 550 and 560 based on policy rules (called ATSSS rules) provided by the network 530. Similarly, in the downlink (DL) direction, the UPF 531 at the edge of 5GC network 530 decides how to distribute the traffic across the two accesses 550 and 560 based on corresponding policy rules (called N4 rules).

The currently defined procedures for ATSSS are XRM-unaware so they cannot be applied to efficiently distribute XRM traffic via multiple accesses. This drawback is resolved by the ATSSS enhancements proposed by the present disclosure.

FIG. 6 illustrates an embodiment of a system 600 diagram supporting XRM traffic in a wireless communication network. The figure shows a remote host 610, a data network 620, a mobile core network 630 of a public land mobile network (PLMN) comprising a UPF 631, an SMF 632, an AMF 633 and a PCF 634. Also shown is a remote unit (UE) 640.

The mobile core network 630 is shown with UPF 631 having ATSSS steering functionality 631a that supports enhancements for XRM traffic. These enhancements are defined in the present disclosure and the ATSSS functionality 631a supporting them is referred to as “XRM-aware ATSSS functionality”. The remote unit 640 is shown as comprising an ATSSS steering function 641 that supports enhancements for XRM traffic (referred to as “XRM-aware ATSSS steering functionality”) and ATSSS rules 642.

A first access path 650 between UPF 631 and remote unit 640 is illustrated as being via interworking function 651 and a non-3GPP access network 652 (with an access point being illustrated). A second access path 660 between UPF 631 and remote unit 640 is illustrated as being via a 3GPP access network 661 (with a base unit being illustrated). The first access path 650 and second access path 660 are illustrated as providing a multiaccess data connection.

The Remote Unit 640 communicates with the Remote Host 610 via a multiaccess data connection (aka PDU Session) in the 5G PLMN supporting data transmission over an access path #1 650 using interworking function 651 and non-3GPP access network 652, and over an access path #2 660 using 3GPP access network 661. The multiaccess data connection terminates at UPF 631.

The UE 640 has an XRM session with the Remote Host 610 and they exchange XRM traffic via the UPF 631. Both the UE 640 and the UPF 631, in the uplink and downlink direction respectively, can distribute the XRM traffic over the access path #1 650 using non-3GPP access 652 and over the access path #2 660 using 3GPP access 661.

The main innovation introduced by this disclosure is that the ATSSS functionality in the UE 640 and in the UPF 631 is XRM-aware, hence, it can identify the PDU sets in the XRM traffic and can handle all PDUs in the same PDU set identically, e.g., forward all of them via the same access path (either 650 or 660).

The disclosure herein provides a network node in a wireless communication network, comprising: a processor; and a memory coupled with the processor, the processor configured to cause the network node to: receive a data stream from a data network external to the wireless communication network, for transmission via a multiaccess data connection to a first network node of the wireless communication network, wherein the multiaccess data connection comprises a plurality of access networks; determine the data stream comprises at least a first packet data unit ‘PDU’ set, wherein each PDU set comprises one or more PDUs; determine steering information associated with the data stream; select, for each PDU set, an access network from the plurality of access networks, based on the steering information; and transmit to the first network node, each PDU set, using PDU set scheduling, wherein the PDU set scheduling comprises transmitting all PDUs of a respective PDU set using the respective selected access network for that PDU set.

In some embodiments the processor is configured to cause the network node to: receive from a second network node, one or more steering rules; and determine using the one or more steering rules, the steering information associated with the data stream.

In some embodiments the processor is configured to cause the network node to determine the steering information associated with the data stream, by: identifying a matched steering rule from the one or more steering rules, the matched steering rule matching one or more features of the data stream.

In some embodiments the processor is configured to cause the network node to determine the data stream comprises at least a first PDU set, by: receiving an indication, in the matched steering rule, that the data stream comprises the at least a first PDU set.

In some embodiments the indication that the data stream comprises the at least a first PDU set comprises, a PDU set delay budget parameter.

In some embodiments the matched steering rule further comprises: a steering functionality; and a steering mode.

In some embodiments the steering functionality is selected from the list of steering functionalities consisting of: multipath QUIC steering functionality; and multipath transmission control protocol ‘TCP’ steering functionality.

In some embodiments the steering mode is selected from the list of steering modes consisting of: load balancing; redundancy; active-standby; priority-based; and smallest-delay.

In some embodiments the processor is configured to cause the network node to transmit to the first network node, each PDU set, using the respective selected access network, using the steering functionality and the steering mode.

In some embodiments the second network node is a Session Management Function ‘SMF’.

In some embodiments the first network node is a user equipment ‘UE’.

The UE may itself transmit a PDU session establishment request to the second network node. The PDU session establishment request may comprise: a request for transmission of the data stream; and steering capabilities of the UE, wherein the steering capabilities comprise an indication that the UE supports PDU set scheduling (i.e. an indication that the UE supports ATSSS enhancements for XRM). The steering capabilities may comprise steering functionalities selected from the list of steering functionalities consisting of: multipath QUIC steering functionality; and multipath TCP steering functionality. The steering capabilities may comprise steering modes selected from the list of steering modes consisting of: load balancing; redundancy; active-standby; priority based; and smallest delay.

In some embodiments the network node is a user plane function ‘UPF’.

In some embodiments the processor is further configured to cause the network node to transmit a registration request to a network repository function ‘NRF’, the registration request comprising an indication that the network node supports access traffic steering, switching and splitting ‘ATSSS’ enhancements for extended reality and media ‘XRM’.

In some embodiments the data stream is an XRM data stream.

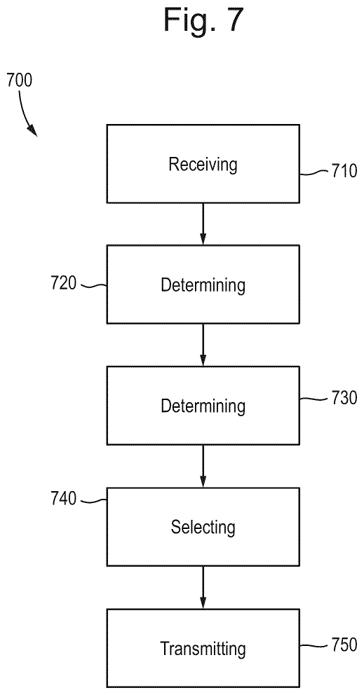

FIG. 7 illustrates an embodiment of a method 700 for wireless communication in a wireless communication network. A first step 710 comprises receiving a data stream from a data network external to the wireless communication network, for transmission via a multiaccess data connection to a first network node of the wireless communication network, wherein the multiaccess data connection comprises a plurality of access networks.

A subsequent step 720 comprises determining the data stream comprises at least a first packet data unit ‘PDU’ set, wherein each PDU set comprises one or more PDUs.

A subsequent step 730 comprises determining steering information associated with the data stream.

A subsequent step 740 comprises selecting, for each PDU set, an access network from the plurality of access networks, based on the steering information.

A subsequent step 750 comprises transmitting to the first network node, each PDU set using PDU set scheduling, wherein the PDU set scheduling comprises transmitting all PDUs of a respective PDU set using the respective selected access network for that PDU set.

In certain embodiments, the method 700 may be performed by a processor executing program code, for example, a microcontroller, a microprocessor, a CPU, a GPU, an auxiliary processing unit, a FPGA, or the like.

In some embodiments, the method comprises receiving from a second network node, one or more steering rules; and determining using the one or more steering rules, the steering information associated with the data stream.

In some embodiments the determining the steering information associated with the data stream, comprises identifying a matched steering rule from the one or more steering rules, the matched steering rule matching one or more features of the data stream.

In some embodiments the determining the data stream comprises the at least a first PDU set, comprises receiving an indication, in the matched steering rule, that the data stream comprises the at least a first PDU set.

In some embodiments the indication that the data stream comprises the at least a first PDU set comprises, a PDU set delay budget parameter.

In some embodiments the matched steering rule further comprises a steering functionality; and a steering mode.

In some embodiments the steering functionality is selected from the list of steering functionalities consisting of: multipath QUIC steering functionality; and multipath transmission control protocol ‘TCP’ steering functionality.

In some embodiments the steering mode is selected from the list of steering modes consisting of: load balancing; redundancy; active-standby; priority-based; and smallest-delay.

In some embodiments the transmitting to the first network node, each PDU set, using the respective selected access network, further comprises transmitting using the steering functionality and the steering mode.

In some embodiments the second network node is an SMF.

In some embodiments the first network node is a user equipment ‘UE’. The UE may itself transmit a PDU session establishment request to the second network node, wherein the PDU session establishment request comprises: a request for transmission of the data stream; and steering capabilities of the UE, wherein the steering capabilities comprise an indication that the UE supports PDU set scheduling. The steering capabilities may comprise steering functionalities selected from the list of steering functionalities consisting of: multipath QUIC steering functionality; and multipath TCP steering functionality. The steering capabilities may comprise steering modes selected from the list of steering modes consisting of: load balancing; redundancy; active-standby; priority based; and smallest delay.

In some embodiments, the method is performed in a UPF.

In some embodiments the method comprises transmitting a registration request to a network repository function ‘NRF’, the registration request comprising an indication that the UPF supports ATSSS enhancements for XRM.

In some embodiments the data stream is an XRM data stream.

FIG. 8 illustrates an embodiment 800 of UE requested multiaccess (MA) PDU session establishment supporting XRM traffic in a wireless communication network. The embodiment 800 comprises a UE 820, a first access network 830, an AMF 840, an SMF 850, a PCF 860, a UPF 870, a remote host 880 and a second access network 890. The steps of the method of the illustrated embodiment 800 are shown as comprising steps relating to control plane procedures: MA PDU session establishment; and steps relating to user plane procedures.

Important messages for explaining the method are discussed. As already specified in 3GPP specifications, before the data traffic (aka user-plane traffic) can be distributed across multiple accesses, a multiaccess (MA) PDU session must be established between the UE 820 and UPF 870. This MA PDU session is established in steps 801-810, which are based on the steps defined in TS 23.502, clause 4.22.2, “UE Requested MA PDU Session Establishment”. However, these steps comprise a number of additional enhancements which will now be discussed.

In step 801a, the UE 820 sends a PDU Session Establishment Request including a Request Type=MA PDU Request and its ATSSS capabilities inside a “5GSM capability” element of the PDU Session Establishment Request. The ATSSS capabilities of the UE 820 indicate the steering functionalities supported by the UE 820, e.g., Multipath TCP (MPTCP), Multipath QUIC (MPQUIC), etc., and the steering modes supported by the UE 820, e.g., “Load-Balancing”, “Redundant”, “Priority-Based”, “Smallest-Delay”, etc. For example, the ATSSS capabilities may indicate that the UE 820 supports the “MPQUIC steering functionality with any steering mode”. In addition, the ATSSS capabilities indicate that the UE 820 supports ATSSS enhancements for XRM traffic or, in other words, that the UE 820 supports XRM-aware ATSSS functionality. As an example, the UE 820 may include in its ATSSS capabilities that: it supports the “MPQUIC steering functionality with any steering mode” and; it supports ATSSS enhancements for XRM traffic. This means that the UE 820 can apply PDU-set scheduling, i.e., it can distribute the XRM traffic across multiple accesses by scheduling all PDUs that belong to the same PDU set to be sent on the same access.

The UE 820 needs to indicate that it supports ATSSS enhancements for XRM traffic so that (a) the SMF 850 can select a UPF 870 that can also support ATSSS enhancements for XRM traffic (in step 805), and (b) the PCF 860 can select steering information applicable to XRM traffic only (in step 804).

In the step 801a, the PDU Session Establishment Request is shown as comprising a PDU session ID, a PDU type, an SSC mode, and the 5GSM capability. The PDU Session Establishment Request is shown as forming part of a UL NAS transport message comprising also the PDU Session ID, S-NSSAI, DNN and the request type.

The UL NAS transport message in step 801a is shown as being transmitted to the first access network 830, with an NGAP uplink NAS transport message comprising the UL NAS transport message being transmitted in step 801b, to AMF 840, from the first access network 830.

In step 802, the AMF 840 creates SM context requirements which are transmitted to SMF 850. The SM context requirements comprise SUPI, PDU session ID, S-NSSAI, DNN, request type=MA PDU request, access type, RAT type, UE location, and the PDU Session Establishment Request.

In step 803, the SMF 850 creates an SM context response message which it transmitted to the AMF 840. The SM context response message is shown as comprising a created indication and a URI of created SM context resource.

In step 804, the SMF 850 retrieves PCC rules from PCF 860, which specify how selected traffic should be steered with ATSSS. For example, the PCF 860 may create the following PCC rule, which specifies that the UDP traffic of App1 should be forwarded using specific QoS parameters (5QI and PDU Set Delay Budget) and should be steered across the two accesses using the MPQUIC steering functionality and the Load-Balancing steering mode. Since the QoS parameters contain a PDU Set Delay Budget, this PCC rule indicates also that the UDP traffic of App1 is XRM traffic. The Load-Balancing percentages (50%-50%) indicate that 50% of the XRM traffic should be sent over 3GPP access and the rest 50% over non-3GPP access. The PCC rule in this example comprises SDF Detection (identifies the matching traffic); UDP traffic of App1; Policy Control (identifies the QoS for the matching traffic); 5QI=2; PDU Set Delay Budget=5 msec; MA PDU Session Control (identifies the ATSSS parameters for the matching traffic); Steering functionality=MPQUIC; and Steering mode=Load-Balancing (50%-50%).

In the PCC rule above, the MA PDU Session Control does not include XRM-specific information. It simply uses an existing ATSSS steering functionality and an existing ATSSS steering mode. However, it does indicate that the matched traffic (UDP traffic of App1) is XRM traffic and, therefore, the UE 820 and UPF 870 should steer this traffic per PDU set, not per individual PDU.

In another example, the PCF 860 creates a different PCC rule that contains MA PDU Session Control with XRM-specific information. Such a PCC rule is shown below and specifies that the UDP traffic of App1 should be forwarded using specific QoS parameters (5QI and PDU Set Delay Budget) and should be steered across the two accesses using the MPQUIC steering functionality and the Load-Balancing steering mode. However, instead of indicating Load-Balancing percentages, it indicates that the high-important PDU sets should be sent over 3GPP access and all other PDU sets (e.g., with medium and low importance) should be sent over non-3GPP access. In this case, the steering information created by PCF 860 contains parameters (importance) usable only for XRM traffic. Such steering information can be created by PCF 860 because the ATSSS Capability receives in step 804a, indicates that the UE 820 supports XRM traffic with ATSSS. The PCC rule in this example comprises SDF Detection (identifies the matching traffic); UDP traffic of App1; Policy Control (identifies the QoS for the matching traffic); 5QI=2; PDU Set Delay Budget=5msec; MA PDU Session Control (identifies the ATSSS parameters for the matching traffic); Steering functionality=MPQUIC; and Steering mode=Load-Balancing (High important: 3GPP access).

More specifically, in step 804a the SMF 850 is shown as transmitting an SM policy control create request, to PCF 860. The create request contains MA PDU indication and ATSSS capability. In step 804b the PCF 860 creates the PCC rules and steering modes for XRM traffic can be selected. In step 804c the PCF 860 is shown transmitting an SM policy control create response, to SMF 850. This contains PCC rules with MA PDU session control information.

In step 805, if the ATSSS capabilities received by SMF 850 indicate that the UE 820 supports ATSSS enhancements for XRM traffic, then the SMF 850 shall select a UPF 870 that can also support ATSSS enhancements for XRM traffic. This selection is based on the existing procedures, i.e., the SMF 850 shall query the NRF (Network Repository Function) for a UPF 870 with certain capabilities. However, when a UPF 870 registers with NRF, it needs also to indicate whether it supports ATSSS enhancements for XMR traffic.

The SMF 850 receives the PCC rules created by PCF 860 in step 804c and from these PCC rules creates N4 rules for the UPF 870 and ATSSS rules for the UE 820. The N4 rules are sent to UPF 870 in step 806a and the ATSSS rules are sent to UE 820 in step 810 (inside the “ATSSS Container” element).

In step 806a, the SMF 850 transmits a PFCP session establishment request to UPF 870. This request comprises SMF-ID, SMF-Session ID, and the N4 rules. In step 806b, the UPF 870 transmits a PFCP session establishment response, back to the SMF 850. This response comprises UPF-ID and a UPF-Session ID.

In step 808, the SMF 850 transmits a N1N2 message transfer request, to AMF 840, comprising a PDU session establishment accept.

In step 809, the SMF 840 transmits an NGAP PDU session resource setup request, to first access network 830.

In step 810, the first access network 830 transmits a DL NAS transport message, to UE 820, comprising PDU session ID, the PDU session establishment accept, PDU type, SSC mode, ATSSS container.

After the multiaccess (MA) PDU session is successfully established (in step 810), the UE 820 and the UPF 870 initiate the user-plane procedures for ATSSS and they apply the received ATSSS rules and N4 rules respectively to decide how to distribute the uplink and the downlink traffic of the MA PDU session across the various accesses of the MA PDU session. The embodiment 800 shows how the UPF 870 handles the downlink XRM traffic but similar handling is applied in the UE 820 for the uplink XRM traffic. The only difference is that the uplink XRM traffic originates internally in the UE 820, e.g., from a UE app, whereas the downlink XRM traffic originates externally to UPF 870, e.g., from the Remote Host 880.

More specifically, in step 811, the UPF 870 receives some data traffic from the Remote Host 880. This traffic should be forwarded to UE 820 via the established MA PDU session.

In step 812, the UPF 870 examines all N4 rules in priority order and finds a “matching” N4 rule, i.e., an N4 rule that matches one or more features of the data traffic (e.g., the source IP address, the protocol, etc.) and can be applied for the data traffic. If this N4 rule includes a PDU Set Delay Budget (or another parameter used for XRM traffic), then the UPF 870 determines that the data traffic is XRM traffic and special ATSSS handling should be applied.

In step 813, the UPF 870 identifies, based on the “matching” N4 rule, steering information for the data traffic. For example, the “matching” N4 rules may contain [Steering functionality=MPQUIC, Steering mode=Load-Balancing (High important: 3GPP access)], which indicates that the high-important PDU sets should be sent over 3GPP access and all other PDU sets (e.g., with medium and low importance) should be sent over non-3GPP access.

In step 814, the UPF 870 (a) identifies the PDU sets in the data traffic, (b) selects an access for each PDU set based on the steering information in the “matching” N4 rule, and (c) sends all PDUs of a PDU set on the selected access.

If the steering information indicates that the PDU sets should be steered across the various accesses based on their importance, then the UPF 870 also determines the importance of each PDU set by using control information embedded in the data traffic (e.g., information in the headers of data packets).

Finally, the UPF 870 distributes the PDU sets of the data traffic across the various accesses of the MA PDU session based on the received N4 rules. A similar operation is carried out by the UE 820 for the XRM traffic that should be sent in the uplink direction.

The embodiment 800 illustrates some PDU sets being sent over first access network 830 and some PDU sets being sent over second access network 890.

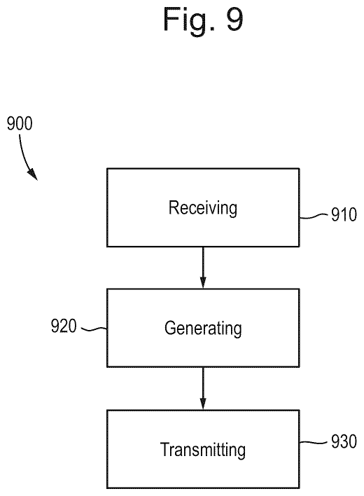

FIG. 9 illustrates an alternative embodiment 900 of a method in a wireless communication network. A first step 910 comprises receiving a PDU session establishment request from a first network node, wherein the PDU session establishment request comprises: a request for transmission of a data stream to a second network node via a multiaccess data connection, wherein the data stream comprises at least a first PDU set, each PDU set comprising one or more PDU, and wherein the multiaccess data connection comprises a plurality of access networks; and steering capabilities of the first network node, wherein the steering capabilities comprise an indication that the first network node supports PDU set scheduling.

A subsequent step 920 comprises generating one or more steering rules comprising an indication that the data stream is to be steered using PDU set scheduling, wherein the PDU set scheduling comprises transmitting each PDU set using a respective access network of the plurality of access networks.

A subsequent step 930 comprises transmitting the one or more steering rules to a third network node.

The method 900 may be performed by a network node in a wireless communication network. The network node comprising: a processor; and a memory coupled with the processor, the processor configured to cause the network node to:

receive a PDU session establishment request from a first network node, wherein the PDU session establishment request comprises: a request for transmission of a data stream to a second network node via a multiaccess data connection, wherein the data stream comprises at least a first PDU set, each PDU set comprising one or more PDU, and wherein the multiaccess data connection comprises a plurality of access networks; and steering capabilities of the first network node, wherein the steering capabilities comprise an indication that the first network node supports PDU set scheduling; generate one or more steering rules comprising an indication that the data stream is to be steered using PDU set scheduling, wherein the PDU set scheduling comprises transmitting each PDU set using a respective access network of the plurality of access networks; and transmit the one or more steering rules to a third network node.

The network node performing the method 900 may be a PCF.

In certain embodiments, the method 900 may be performed by a processor executing program code, for example, a microcontroller, a microprocessor, a CPU, a GPU, an auxiliary processing unit, a FPGA, or the like.

The disclosure herein provides the novel enhancement of ATSSS functionality for supporting XRM traffic in a wireless communication network. More specifically the operation of a UE, UPF, SMF and PCF are enhanced with novel aspects. Even more specifically, when the UE requests an MA PDU session, it indicates whether it supports ATSSS enhancements for XRM traffic; when the UE supports ATSSS enhancements for XRM, the PCF can create PCC rules that contain XRM-specific steering information (e.g. steering based on the importance of the PDU sets); when a UPF registers with NRF, it indicates whether it supports ATSSS enhancements for XRM traffic; When the UE supports ATSSS enhancements for XRM, the SMF can select a UFP that can also support ATSSS enhancements for XRM; the UPF identifies whether a downlink data stream is an XRM stream (based on the N4 rules) and distributes the PDU sets of the stream (not the individual PDUs) across the accesses of the MA PDU session using steering information associated with the data stream; and the UE identifies whether a uplink data stream is an XRM stream (based on the ATSSS rules) and distributes the PDU sets of the stream (not the individual PDUs) across the accesses of the MA PDU session using steering information associated with the data stream.

The disclosure provides an apparatus (for instance a UPF) in a mobile communication network comprising a first transceiver that communicates with a user equipment via a multiaccess data connection comprising a plurality of access networks. The apparatus further comprising a second transceiver that communicates with a data network external to the mobile communication network. The apparatus further comprising a processor that: receives via the second transceiver a data stream to be sent to the user equipment via the multiaccess data connection; determines that the data stream contains a sequence of packet data unit (PDU) sets, each PDU set comprising one or more PDUs; identifies steering information associated with the data stream; selects, for each PDU set, an access network from the plurality of access networks using the steering information; and sends all PDUs of each PDU set to the user equipment via the selected access network.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3^{rd} generation partnership project; 5GC, 5G core; AMF, access and mobility management function; ATSSS, access traffic steering, switching and splitting; DL NAS, downlink non-access stratum; DNN, data network name; MA PDU, multiaccess protocol data unit; MPQUIC, multipath QUIC; MPTCP, multipath TCP; N3IWF, non-3GPP inter-working function; NAS, non-access stratum; NGAP, NG application protocol; NG-RAN, NG radio access network; NRF, network repository function; PCC, policy and charging control; PCF, policy control function; PDU, protocol data unit; PFCP, packet forwarding control protocol; QoS, quality of service; RAT, radio access technology; SMF, session management function; S-NSSAI, single network slice selection assistance information; SSC, service and session continuity; SUPI, subscription permanent identifier; TCP, transmission control protocol; TNGF, trusted non-3GPP gateway function; UE, user equipment; UL NAS, uplink non-access stratum; UPF, user plane function; WLAN, wireless local area network; and XRM, extended reality and media.

1. A network node in a wireless communication network, comprising:
at least one memory; and
at least one processor coupled with the at least one memory and configured to cause the network node to:
receive a data stream, from a data network external to the wireless communication network, for transmission via a multiaccess data connection to a first network node of the wireless communication network, wherein the multiaccess data connection comprises a plurality of access networks;
determine the data stream comprises at least a first packet data unit (PDU) set, wherein each PDU set comprises one or more PDUs;
determine steering information associated with the data stream;
select, for each PDU set, an access network from the plurality of access networks based on the steering information; and
transmit, to the first network node, each PDU set using PDU set scheduling, wherein the PDU set scheduling comprises transmitting all PDUs of a respective PDU set using the respective selected access network for that PDU set.

2. The network node of claim 1, wherein the at least one processor is further configured to cause the network node to:
receive, from a second network node, one or more steering rules; and
determine, using the one or more steering rules, the steering information associated with the data stream.

3. The network node of claim 2, wherein the at least one processor is configured to cause the network node to determine the steering information associated with the data stream, by:
identifying a matched steering rule from the one or more steering rules, wherein the matched steering rule matches one or more features of the data stream.

4. The network node of claim 3, wherein the at least one processor is further configured to cause the network node to determine the data stream comprises at least a first PDU set, by:
receiving an indication, in the matched steering rule, that the data stream comprises the at least first PDU set.

5. The network node of claim 4, wherein the indication that the data stream comprises the at least first PDU includes a PDU set delay budget parameter.

6. The network node of claim 5, wherein the matched steering rule further comprises:
a steering functionality; and
a steering mode.

7. The network node of claim 6, wherein the steering functionality is selected from a the list of steering functionalities, including:
a multipath quick UDP internet connection (QUIC) steering functionality; and
a multipath transmission control protocol (TCP) steering functionality;

8. The network node of claim 6, wherein the steering mode is selected from a list of steering modes, including:
load balancing;
redundancy;
active-standby;
priority-based; and
smallest-delay.

9. The network node of claim 6, wherein the at least one processor is further configured to cause the network node to transmit, to the first network node, each PDU set using the respective selected access network, the steering functionality, and the steering mode.

10. The network node of claim 2, wherein the second network node is a Session Management Function (SMF).

11.-12. (canceled)

13. The network node of claim 1, wherein the at least one processor is further configured to cause the network node to transmit a registration request to a network repository function (NRF), and wherein the registration request comprises an indication that the network node supports access traffic steering, switching and splitting (ATSSS) enhancements for extended reality and media (XRM).

14. The network node of claim 1, wherein the data stream is an extended reality and media (XRM) data stream.

15. A method in a wireless communication network, the method comprising:
receiving a data stream, from a data network external to the wireless communication network, for transmission via a multiaccess data connection to a first network node of the wireless communication network, wherein the multiaccess data connection comprises a plurality of access networks;
determining the data stream comprises at least a first packet data unit (PDU) set, wherein each PDU set comprises one or more PDUs;
determining steering information associated with the data stream;
selecting, for each PDU set, an access network from the plurality of access networks based on the steering information; and
transmitting, to the first network node, each PDU set using PDU set scheduling, wherein the PDU set scheduling comprises transmitting all PDUs of a respective PDU set using the respective selected access network for that PDU set.

16. The method of claim 15, further comprising:
receiving, from a second network node, one or more steering rules; and
determining, using the one or more steering rules, the steering information associated with the data stream.

17. The method of claim 16, wherein determining the steering information associated with the data stream comprises:
identifying a matched steering rule from the one or more steering rules, wherein the matched steering rule matches one or more features of the data stream.

18. The method of claim 17, wherein determining data stream comprises the at least first PDU set, the method further comprises:
receiving an indication, in the matched steering rule, that the data stream comprises the at least first PDU set.

19. The method of claim 18, wherein the indication that the data stream comprises the at least first PDU set comprises a PDU set delay budget parameter.

20. The method of claim 17, wherein the matched steering rule further comprises:
a steering functionality; and
a steering mode.

21. (canceled)

22. The method of claim 20, wherein the steering mode is selected from a list of steering modes, including:
load balancing;
redundancy;
active-standby;
priority-based; and
smallest-delay.

23.-26. (canceled)

27. The method of claim 15, further comprising:
transmitting a registration request to a network repository function (NRF), wherein the registration request comprises an indication that the network node supports access traffic steering, switching and splitting (ATSSS) enhancements for extended reality and media (XRM).

28. (canceled)
